(19) United States
(12) Patent Application Publication
(10) Pub. No.: US 2002/0138387 A1
(43) Pub. Date: Sep. 26, 2002

(54) Method and apparatus for maintaining a uniform net asset value per share or unit

(75) Inventor: Kenneth C. Griffin, Chicago, IL (US)

Correspondence Address: SIDLEY AUSTIN BROWN & WOOD LLP, 717 NORTH HARWOOD, SUITE 3400, DALLAS, TX, 75201, US

(73) Assignee: CITADEL INVESTMENT GROUP, L.L.C.

(21) Appl. No.: 10/044,519

(22) Filed: Jan. 11, 2002

Related U.S. Application Data
(60) Provisional application No. 60/261,277, filed on Jan. 12, 2001.

(51) Int. Cl. G06F 17/60

(52) U.S. Cl. 705/36

(57) ABSTRACT

A method for maintaining a uniform asset value per share and complete fungibility among all shares in investment funds while providing for differential fees and credits, as well as any other factors which may be differentially applicable to different investors, separately in respect of each investor. The method also permits accounting for a single investor's shares to be classified into different categories in respect of such factors as redemption rights or fees due, while maintaining a complete fungibility among such shares so that it is not necessary to identify any particular shares as belonging to any specific category. The present invention also makes it possible to program a single accounting method for both domestic investment funds organized as partnerships, typically not classifying investments in such entities into any uniform quanta, and offshore investment funds organized as corporations, trusts or other entities, typically classifying investments in such entities into uniform quanta such as shares or units.

### TECHNICAL FIELD OF THE INVENTION

The present invention pertains in general to investment fund accounting methods, and in particular to the ability of such funds to use shares or other units (collectively, “shares”) which maintain a uniform (although fluctuating) value while tracking and equitably distributing various fees and credits associated with investments in such funds, such as performance fees (“PFs”) and reversals thereof, differently among investors. The invention also permits tracking differential features applicable to each individual investor's investment. The method can be performed by any number of techniques, although a computer implemented method is preferred.

### BACKGROUND OF THE INVENTION

The typical United States based private investment fund sponsor operates funds organized both under the laws of the United States and under the laws of one or more offshore jurisdictions—Ireland, Bermuda, Guernsey, the Cayman Islands, the Bahamas, etc. U.S. taxable investors invest in the domestic fund, while non-U.S. investors and U.S. tax-exempt investors invest in the offshore fund. The offshore fund structure (typically either a company or a trust) provides tax advantages to U.S. tax-exempt investors, is attractive to offshore investors, and facilitates compliance with the Investment Company Act of 1940.

The typical U.S. private investment fund is formed as a partnership or a limited liability company and provides U.S. investors with the equitable (in terms of effecting financial and tax allocations among different investors)-i.e., partnership-accounting including the equitable investor-by-investor allocation of fees and credits which differ among different investors (e.g., PFs). In the partnership context, differential fees and credits do not present the accounting problem which the present invention resolves in the case of offshore funds, as in the partnership context there is no perceived or actual need to maintain a uniform quantum of investment (i.e., a “share” or a “unit”). Partnership accounting methods maintain an individual capital account for each investor, potentially with a value different than the capital account of each other investor, and these capital accounts are maintained on an aggregate and non-quantized basis—as a simple dollar (or other currency) amount. Offshore, however, the perceived or actual need to maintain a uniform value per share has necessitated adoption of entirely different accounting systems in which, for example: (i) differential fees and credits have been allocated through requiring additional payments by investors subject to subsequent reversal; (ii) the persons who would otherwise be recipients of differential credits have been required to waive payment of a portion of such credits; (iii) calculating fees which should properly differ from certain investors but not others on an overall find basis, effectively requiring all investors to pay a portion of such fees; and (iv) other complicated, economically inefficient and/or inequitable and administratively burdensome accounting mechanisms.

The bifurcation between domestic and offshore fund accounting can be both onerous and expensive, as well as in many cases inequitable. The present invention enables investments in offshore companies to be accounted for on the same basis as investments in partnerships while maintaining a uniform asset value per share. Not only does this make possible the equitable allocation of differential fees and credits among investors, but it may also permit the use of a single accounting system for all funds organized by a given sponsor, whether formed as domestic partnerships or offshore companies or trusts.

### Definitions

Performance Fee (PF): The fee owed to a fund manager (also called an advisor or) equal to a portion of the positive performance of an investment over a specified PF calculation period (typically a quarter or a year). For purposes of the examples and illustrations in this Application, a 20% PF is assumed. However, clearly any percentage or even non-percentage based method of payment could be chosen. PFs could also represent any item of cost or expense, or other items of profit and loss, which accrues differentially as between different investors.

Depreciation Deposit (DD): An amount paid by investors in certain offshore funds, accounted for using the current art, equal to the PF due on gains which, in the case of certain other earlier investors, are less than or equal to their loss carryforwards.

Asset value (AV): The total value of an asset, such as a “share,” without reduction for accrued PFs.

Equalization Factor (EF): An amount paid by certain investors in investment funds, accounted for using the current art, equal to the difference between the asset value and the net asset value of the shares they acquire.

Net asset value (NAV): The asset value of an asset, less any accrued PFs. In other words, the asset value of a share reduced any applicable PF=net asset value.

Total asset value (TAV) of a fund: The sum of the asset values of all the shares in the fund.

Loss carryforward: The amount of any losses incurred by an investor's interest in the fund since the end of the most recent PF calculation period as of which such interest was subject to a PF (or date of initial investment if no PF has been due). The loss carryforward (as adjusted for withdrawals made by the investor in question) must generally be earned back before an additional PF can be earned by the advisor in respect of such investor's interest. However, the use of the loss carryforward calculation is not a necessary feature of the invention; the loss carryforward is simply one commonly used component in the calculation of the PF.

The following hypothetical illustrates one of the difficulties of maintaining uniform share values in an environment of differentially accruing fees and credits. As mentioned above, several methods for dealing with these difficulties have been used in the past, certain of which are outlined below. However, each of these methods has potentially material drawbacks associated with it, drawbacks which are minimized or eliminated by the present invention.

TABLE 1

| | T₁ | T₂ | T₃ |
|---|---|---|---|
| I₁ | $100 | $90 | $95 |
| I₂ | | $90 | $95 |
| TAV | $100 | $180 | $190 |

Table 1 is a simplified representation of an investment fund which has two investors, investor I₁ and investor I₂. T₁, T₂, and T₃ represent three different points in time during the initial PF calculation period for the investment fund.

One common requirement or desired result for offshore funds is that they must maintain a uniform value per share (as in an operating company). Therefore, at any given point in time, a share owned by investor I₁ must have the same “value” (a concept which requires differentiating net asset value and asset value) as a share owned by investor I₂. This constraint creates difficulties when, for example, investors invest in a fund at different points in time, as illustrated in Table 1.

Referring now to Table 1, investor I₁ buys one share for $100 at T₁. At T₂, the value of the share has dropped to $90. At T₃, the value of the share has increased to $95. With regard to the second investor, investor I₂ buys one share at T₂, when the value of a share is $90. Then, at T₃, the share owned by I₂ is worth $95. The total asset value of the fund at T₁,is $100, the total asset value at T₂ is $180, and the total asset value at T₃ is $190.

Looking now at T₃, it is clear that investor I₁ has a net loss of $5 since the inception of his investment, which has declined in value from $100 to $95. For investor I₂, however, the value of his investment has increased from $90 to $95, representing a net increase of $5. Under this scenario, investor I₁ should owe no PF to the advisor since investor I₁ has no gain on his investment. Investor I₂, however, should owe a PF to the advisor. In this example, assuming a 20% PF, investor I₂'s $5 net gain should result in a $1 PF owed to the advisor.

At T₃ the advisor is entitled to a $1 PF. However, recall the requirement/desire to maintain a uniform net asset value per share. Because of this, one cannot simply deduct $1 from investor I₂'s share, since then investor I₂'s share would be worth $94, while investor I₁'s share would be worth $95. In order to maintain uniformity in the value of each share, one solution would require the allocation of the $1 PF equally between both I₁ and I₂, resulting in both shares having an asset value of $94.50. However, it is inequitable to charge investor I₁ a $0.50 PF because he has actually lost $5 since he first invested. Likewise, equally distributing the PF between the two investors would be an unwarranted windfall for investor 12, who would be paying only one-half of the full 20% PF due on his investment gain of $5.

The art has heretofore dealt with this problem in a variety of ways.

One solution has been simply to prohibit future investors from investing in a fund after it has been established; in other words, either by eliminating investor I₂ or causing T₂=T₁. This approach has material adverse economic consequences as funds typically raise most of their capital after they have been operating for some time and have performed favorably.

Another possible solution has been for the advisor (fund manager) to waive a portion of his PF, so that investor I₂ has a “free (PF) ride” on the first $10 of gain. However, this inflicts a clear economic loss to the advisor who is denied his otherwise rightfully earned PF and giving investor I₂ a windfall.

Various accounting schemes have been developed to avoid the potentially materially adverse effects of either prohibiting subsequent investors in a fund or imposing a “free (PF) ride” on the advisor. These schemes have addressed some, but not all, of the associated problems which are resolved by the present invention.

The simplest of these schemes eliminates the problem by compelling the investors to accept the risk of an inequitable allocation of PF. The investment fund as a whole pays a PF based on its overall performance and that PF reduces the asset value per share equally for all shares, irrespective of when they were issued or their investment experience in the fund. This method is widely disfavored due to its obvious inequity (potentially both to the investors and to the advisors, depending on the interrelationship of find performance and subscriptions/redemptions).

Another such scheme compels later investors to pay an EF or a DD, depending on the status of the fund at the time of the later investments.

TABLE 2

| | | T₁ | T₂ | T₃ |
|---|---|---|---|---|
| I₁ | NAV | $100 | $108 | $108 |
| | PF | 0 | 2 | 2 |
| | AV | 100 | 110 | 110 |
| I₂ | NAV | X | 108 | 108 |
| | EF | X | 2 | 2 |
| | INVESTMENT | | 110 | |

Table 2 illustrates the use of an EF when a second investor invests during a PF calculation period, and at a time when an earlier investor has accrued gains. In this hypothetical, investor I₁ purchases a share for $100 at T₁. At this time, the net asset value and asset value are both $100, since no PF has yet accrued. By T₂, the asset value of the share has risen to $110. Because the advisor is entitled to a PF (again, assume 20%), the net asset value at T₂ is $108, and the accrued PF is $2. At T₃, the value of the share has not changed since T₂, thus meaning that the net asset value of the share remains $108, and the accrued PF for the advisor remains $2.

Now assume that investor I₂ purchases a share at T₂. At T₂, while the net asset value of investor I₁'s share is only $108, since $2 is contingently owed to the advisor (subject to possible reversal in the event of subsequent losses during the current calculation period), investor I₁ nevertheless has $110 invested in the fund, as the contingent PF is not yet due. As a result, this scheme requires investor I₂ to invest not $108—the net asset value per share—but $110, so that I₂ has as much risk as I₁. The $2 difference between the amount invested and the net asset value per share is called the EF.

The EF is held in an account in the name of I₂ and participates in the fund's profits and losses. At T₃—the end of the PF calculation period—investor I₁ owes $2 to the advisor (i. e., the PF is no longer accrued, but due). However, at T₃, investor I₂ owes nothing to the advisor, since his investment has not appreciated since he purchased his share at T₂. After payment of the $2 PF, the net asset value per share at T₃ is $108. The $2 EF attributable to investor 12 is then invested in additional shares so that investor I₂ holds 1 2/108 shares with a net asset value per share of $108, and investor I₁ holds one share with a net asset value per share of $108.

On the other hand, had there been losses subsequent to T₂, I₂'s EF would be reduced, thereby preventing I₂ from unfairly benefiting from the reversal of the PF accrued with respect to I₁'s shares. If, for example, the fund lost $10 in the period T₂-T₃, this would result in the net asset value per share declining, on a preliminary basis, to $103. However, the $5 loss attributable to I₁ would cause the PF accrued against his share to decrease from $2 to $1. Accordingly, the net asset value of his share would be $104, not $103. Had I₂ invested at T₂ at a net asset value of $108, in order to maintain a uniform net asset value per share the $1 decrease in the accrued PF would have to be allocated equally between I₁'s and I₂'s shares. This would result in a net asset value per share of $103.50, not $104. I₁ would have lost $0.50 unfairly. The EF is used to prevent this by being reversed, and increasing the aggregate net asset value of the fund in an amount sufficient to ensure that I₁ receives the full benefit of the reversal of the PF attributable to I₁'s shares. Accordingly, at T₃, investor I₁ would have one share with a net asset value of $104 and a $1 accrued PF, and I₂ would have one share with a net asset value of $104 and a remaining EF of $1. This $1 would then be invested in new shares; I₁ would hold 1-1/104 shares, and I₂ would hold one share, all with a net asset value per share of $104.

In this way, share value uniformity is achieved, while eliminating inequities in terms of the payment of PFs. However, the EF mechanism has been the source of considerable confusion among investors and fund sponsors alike.

Furthermore, the EF/DD scheme has a clear economic cost in the case of investors who acquire shares when a loss carryforward exists. If investor I₂ invests at a point in time when I₁ has sustained a net loss, then the EF/DD scheme has forced I₂ to provide a DD—a situation illustrated by Table 3.

TABLE 3

| | | T₁ | T₂ | T₃ |
|---|---|---|---|---|
| I₁ | NAV | $100 | $90 | $100 |
| | PF | 0 | 0 | 0 |
| | AV | 100 | 90 | 100 |
| I₂ | NAV | X | 90 | 100 |
| | DD | X | 2 | 2 |
| | | | 92 | 102 |

Referring to Table 3, at T₁, a share has a net asset value of $100. At T₂, the net asset value has dropped to $90. Then, by T₃, the net asset value of a share has again risen back to its starting point, $100. In this illustration, investor I₁ purchases one share at T₁, and investor I₂ purchases one share at T₂. However, even though the net asset value is $90 at T₂, I₂ does not simply pay $90 for one share at T₂, since if he did so, there would be a potential non-uniformity in share value at T₃, unless the advisor for the fund agreed to waive the PF due on I₂'s share. Accordingly, at T₂, investor I₂ is required to pay, in addition to the asset value/net asset value (which are equal at T₂ as there is no accrued PF), a DD equivalent to the PF that would be payable on a gain on I₂'s share equal to the amount of the loss carryforward for investor I₁ at T₂ (i.e., 20% of $10, or $2). At T₃, investor I₂'s DD is used to pay the PF for I₂'s gains, while investor I₁, who has no net gain, pays no fee. Because the DD is kept outside of the share accounting system, a uniform net asset value per share is maintained. At T₃, after payment of the PF, the total asset value of the fund is $200, with each of investor I₁ and investor I₂ owning a single share, each share with a net asset value of $100, and each of I₁ and I₂ has paid a PF commensurate with his investment experience in the fund.

There is, however, an economic loss for investor I₂ from the DD. In order to ensure its availability to pay the PF potentially due from I₂ but not from I_{1,} as well as that I₂ not have more at risk than I₁ having to fund the DD, the DD does not participate in the profit and loss of the fund but rather is invested in T-bills or other “riskless” short-term deposits. I₂ effectively pays the cost of maintaining a uniform asset value per share by being required to fund the non-participating DD.

Another past scheme used to address the differential PF/uniform share value problem has involved the issuance of additional shares and/or the adjustment of the number of current shares held as at the end of each PF calculation period.

TABLE 4

| | | |
|---|---|---|
| T₁ | T₂ | T₃ |

| | | | | |
|---|---|---|---|---|
| I₁ | NAV | $100 | $108 | $100 |
| | PF | 0 | 2 | 0 |
| | AV | 100 | 110 | 100 |
| I₂ | NAV | X | 108 | 98 |

Referring now to Table 4, investor I₁ purchases one share at $100 at T₁. At T₂, the value of the share has appreciated to $110, $2 of which is an accrued PF. By T₃, the share has again dropped to $100, and the PF has reversed.

Assume investor I₂, acquires a share at T₂. In this case—unlike in the EF scheme, in which I₂ would invest the full $110 asset value per share prior to any PF accrual—I₂ purchases a share at the net asset value of $108. At T₂, the uniform net asset value per share is $108, the asset value of the fund is $218, and there is a $2 accrued PF attributable to investor I₁. At T₃, the net asset value of each share has preliminarily dropped from $108 to $98, a loss of $10 per share. The total asset value of the fund at T₃ is $198—the total paid for the two shares ($100 plus $108), plus the initial $10 gain, less the $20 loss, at T₃.

At T₃, the share value is determined by that of the most recently acquired share (I₂'s), i.e., $98 per share. At T₃, investor I₁'s total investment is $100. At $98 per share, this means that investor I₁ has a total of 1 2/98 shares. Investor I₂'s total investment is $98. At $98 a share, this means that investor I₂ will have exactly one share.

TABLE 5

| | | |
|---|---|---|
| T₁ | T₂ | T₃ |

| | | | | |
|---|---|---|---|---|
| I₁ | NAV | $100 | $90 | $100 |
| | PF | 0 | 0 | 0 |
| | AV | 100 | 90 | 100 |
| I₂ | NAV | | $90 | $98 |
| | PF | | 0 | 2 |
| | AV | | 90 | 100 |

Referring now to Table 5, investor I₁ purchases one share for $100 at T₁. At T₂, the asset value/net asset value per share has dropped from $100 to $90. By T₃, the asset value/net asset value per share has recovered to its starting point, $100. Investor I₂ purchases one share at T₂. The purchase value of that share is $90. By T₃, his $90 share has appreciated to $100 in asset value, $98 net asset value due to the $2 accrued PF.

Shares are then reallocated at T₃. After the $2 PF is paid to the advisor by investor I₂, the total asset value of the fund is $198. The value per share is that of the most recently acquired share, i.e., $98. Using this new value per share ($98), investor I₁, has invested $100 and holds 1 2/98 shares. Similarly, investor I₂'s total investment is now $98 ($100, minus the $2 PF). At $98 a share, this means that investor I₂ holds exactly one share.

The foregoing scheme, while complicated, achieves the correct result without the opportunity cost of the DD, provided that no investor acquires shares at more than one time. However, if an investor does acquire shares at more than one time, this scheme has no capability of adjusting for the fact that even though there is a profit on a later acquired tranche of shares the investor in fact should owe no PF due to counterbalancing losses on an earlier acquired tranche. In fact, each of the aforementioned schemes that involves EFs/DDs, as well as that involving the revaluation and issuance of new shares (sometimes referred to as “equalization shares”), are blind to subsequent investments by existing investors. By way of contrast, in partnership accounting the investor who acquires an investment interest at more than one time is equitably treated. He is not subject to a PF until his overall investment is profitable. In the equalization share method, if I₁ and I₂ were the same investor, the net asset value per share would still be calculated as if a PF were due on the increase in the value of the share acquired at T₂. However, there should be no such PF until the loss carryforward with respect to the share acquired at T₁, had been earned back. The aforementioned schemes have the common failing of tracking PF by tranche of share, not by investor.

When analyzing multiple investments by a single investor, it is important to recognize that in a partnership accounting system, investments are typically tracked person-by-person, rather than by investment-by-investment. One reason for this is simply illustrated.

TABLE 6

| | | T₁ | T₂ | T₃ |
|---|---|---|---|---|
| I₁ | Series A | $100 | $90 | $95 |
| | Series B | | $90 | $95 |

Referring to Table 6, a single investor (investor I₁) invests in the same fund at two different points in time, T₁ and T₂. At T₁, the value of a share is $100. At T₂, the value has fallen to $90 a share, and by T₃, the share value has risen back to $95. Referring to investor I₁'s first purchase as “Series A” stock, and referring to his second investment as “Series B” stock, if these investments were treated separately, the advisor would be entitled to a PF on the Series B stock, which had appreciated from $90 to $95 (at a 20% PF, this fee would equal $1). However, overall, investor 11 has merely broken even, since his Series A stock has actually decreased in value. Under this scenario, tracking investment-by-investment rather than investor-by-investor is inequitable to investor I₁.

### SUMMARY OF THE INVENTION

The problems of (i) accounting for the possibility of multiple investments by the same investor, (ii) equitably allocating PFs, (iii) maintaining a uniform asset value per share, and (iv) avoiding economic loss for the advisor (the “loss carryforward free ride”) or the investor (the DD) are all addressed by the present invention.

In order to ensure equitable treatment of each investor in all investment fund performance scenarios, it is necessary to track accrued PFs, loss carryforwards, and the like, investor-by-investor, rather than investment-by-investment. The art, as described above, does not do so. The invention does, while also maintaining a uniform asset value per share.

The first embodiment of the present invention is a computer implemented accounting system which permits investment sponsors to maintain the uniformity and fungibility of the shares acquired by different investors while equitably allocating differential fees and credits among such investors.

By preserving the fungibility of the shares despite material differences among the fees and credits applicable to various shareholders, the invention permits private investment funds to accommodate numerous different investors, make individualized arrangements with all or substantially all the investors while, nevertheless, maintaining wholly uniform and fungible shares.

Another embodiment of the present invention is an accounting system which permits maintaining different categories of an individual shareholder's shares, without differentiating among the shares designated to each of these different categories. This permits accounting for each individual shareholder's overall shareholding as itself being subdivided into shares subject to different redemption and other terms (“categories” being the term used herein to refer to shares subject to such different terms), while maintaining the fungibility of such shares and obviating the need to identify specific shares as belonging to specific categories. By tracking the categories solely as bookkeeping entries, the present invention permits shares to be redeemed, transferred, etc., against the bookkeeping balance in a category without any share itself having to be identified to or incorporating the characteristics of any given category.

The present invention can enable fund sponsors to maintain uniform and wholly fungible shares despite a wide range of differential variables applicable to the shares held by different shareholders as well as by each individual shareholder.

### BRIEF DESCRIPTION OF THE DRAWINGS

For a more complete understanding of the present invention and the advantages thereof, reference is now made to the following description taken in conjunction with the accompanying drawings.

FIG. 1 is a schematic representation of the first embodiment of the apparatus of the present invention.

FIG. 2 is a schematic illustration of a method of the present invention as implemented in a software flow diagram, whereby the realizable value (or net asset value) of the investment held by each investor in a fund is calculated.

FIG. 3 is a sequential flow diagram as used in software illustrating the recomputation and reallocation of shares to individual investors upon the occurrence of a realization event.

FIG. 4 is a schematic representation of the second embodiment of the present invention.

FIG. 5 is a schematic representation of the method of a second embodiment of the present invention implemented in a software flow diagram, wherein a given investor's shares are divided into different categories, and wherein redemptions, transfers, debits, credits, or the like are attributed to the various categories of shares held by such investor pursuant to a predetermined formula.

### DETAILED DESCRIPTION

The present invention consists of a system of accounting for all shares on an “asset value” basis—i.e., a value unreduced by differential fees and credits—while confining the differential fees and credits applicable to different investors to agreements extraneous to the fund's accounting system. By divorcing share value accounting from the differential fees and credits—as well as from different categories of shares held by the same investor in the second embodiment of the invention—the present invention easily permits a single series of shares of equal asset value to be held by all investors. Multiple classes or series may also be issued if necessary or desirable for regulatory or other reasons, in which case the uniformity and fungibility of the shares is maintained within each such class or series.

A net asset value monitor tracks the differential fees and credits on an investor-by-investor basis. This system generates a balance due from or to each shareholder which reduces or increases the realizable value of such shareholder's overall investment, i.e., the net asset value of such investment. However, all differential fees and credits are extraneous to the asset value per share, which by definition does not reflect any such fees and credits. The asset value per share of all shares is the same; however, investments held by two different shareholders with the same number of shares can have materially different realizable (net asset) values. The net asset value monitor also tracks whether the same investor has purchased shares at more than one time. If so, the net asset value monitor calculates differential fees and credits based on the shareholder's overall investment in the fund, not on the basis of the different tranches of shares acquired at different times (as in the other methods of accounting, using EFs/DDs and equalization shares, outlined above). Consequently, even immediately after a tranche of shares is issued, the realizable value (net asset value) of such shares in the hands of one investor may differ from such value in the hands of another investor, although all shares are fungible on an asset value basis.

Each time share cancellations are generated by the net asset value monitor, a signal is sent to the fund's periodic reporting system to disclose the cancellation—both by dollar and share amount—to the affected investor in the immediately following periodic investor report.

By storing differential fees and credit data by individual shareholder identifiers, the net asset value monitor is able to accommodate any number of different sources of differential fees and credits for different investors, as well as interim changes and adjustments to such differential fees and credits, while entirely insulating the value per share accounting from these individualized inputs. Consequently, fund sponsors are given the added flexibility that these inputs may be modified or eliminated from time to time without impacting the fund's valuation systems.

The second embodiment of this invention permits an investor's shares to be divided into different categories for a variety of different functions, for example, for purposes of determining when the shares can be redeemed. These categories may be individualized to each investor or may be common among different groups of investors. A category allocator distributes the differential characteristics among the different categories for purposes of achieving the share differentiations for which the categories have been developed, and signals the fund's periodic reporting system to communicate this information to investors in the immediately following periodic investor report. As a final step, the category allocator distributes the asset value of the individual investor's shares among the different categories so that the sum of the asset value of the categories equals the asset value of the investor's overall shareholding. In addition, the distribution of asset value among the different categories permits the calculation of the number of shares of each category which must be cancelled or acquired when an event occurs causing the differential fees and/or credits maintained in the net asset value monitor to become due. The category allocator has the capability of maintaining the fungibility of all shares while also maintaining material distinctions among the categories. Individual shares are not identified to a category; rather, shares are redeemed, transferred, etc., as debits or credits against the bookkeeping balances in such categories. The uniformity of the shares irrespective of the materially different categories to which a shareholder's overall investment is distributed is consistent with the calculation of differential fees and credits on the basis of a shareholder's overall investment, not share by share.

Both embodiments of the present invention are capable of incorporating a wide range of different variables. The functionality of the present invention is independent of the type or number of these variables.

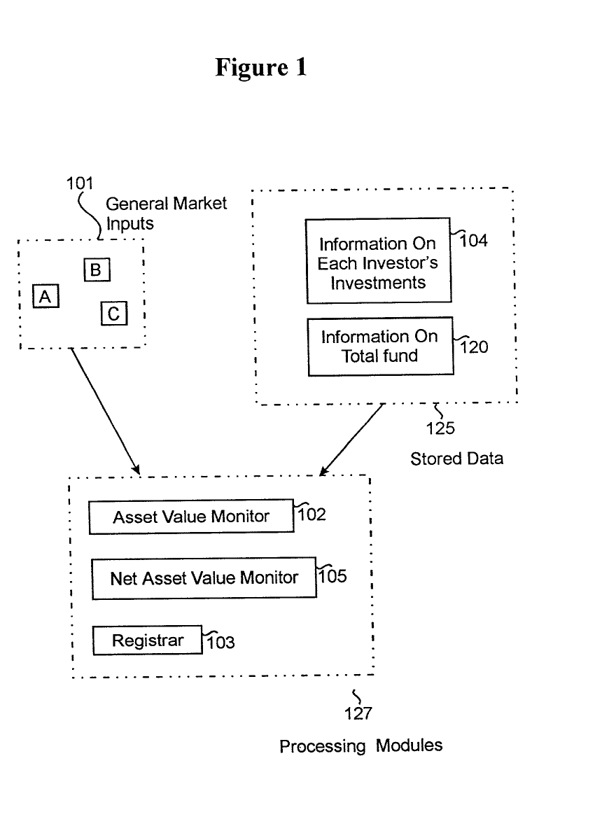

FIG. 1 illustrates a first embodiment of the apparatus of the present invention. Included in the apparatus are a stored data 125 and processing modules 127. The general market inputs 101 are not part of the apparatus, but rather are data relating to the performance of the investment fund which is utilized by the apparatus. Processing modules 127 comprise at least three aspects. First is an asset value monitor 102. The asset value monitor is used to determine the total asset value of the fund at a given point in time. Also included in the processing modules 127 is a net asset value monitor 105. The net asset value monitor 105 tracks and computes the net asset value of each investor's investment based on the performance of the fund as a whole. Also included in the processing modules 127 is a registrar 103. The registrar 103 performs various functions, including the computation of the total investment value for a given investor, as well as the realizable value (or net asset value) for each individual investor. It should be apparent that the important aspect of processing modules 127 is their ability to compute and track the various information discussed herein. It is not essential that the various functionalities be separated into the various subcomponents listed herein.

The apparatus also contains a stored data 125. The stored data 125 includes information relating to the investment fund as a whole 120. This information would include data such as the total number of outstanding shares in the fund, total capitalization of the fund, and the like. In addition, stored data 125 also includes information on each of the specific investor's investments 104. This individual investor information 104 would include data such as the number of shares owned by a particular investor, when each of those shares was purchased, and the like. As discussed previously, the stored data 125 and processing modules 127 operate using general market inputs 101 to perform the various steps of the methods of this invention.

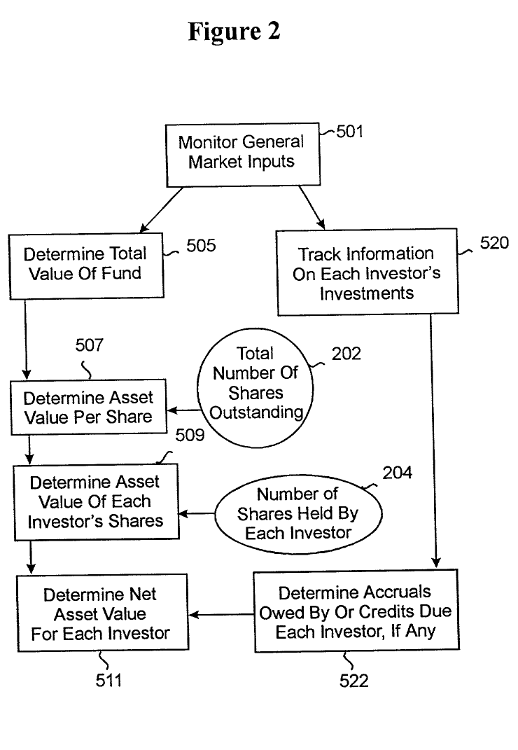

Referring now to FIG. 2, FIG. 2 is a flow diagram of the method of the first embodiment of the present invention. Although the steps do not have to be performed in this order, the order discussed herein is the preferred embodiment. The first step 501 is to monitor the general market inputs. After monitoring these inputs, such as the value of the various holdings of the fund and the like, the next step 505 determines the total value of the fund's portfolio. Next, using the total value of the fund just determined, in conjunction with the value representing the total number of outstanding shares 202 in the fund, step 507 determines the asset value (i.e., not altered by differential fees or credits) per share. This value can then be reported to stock exchanges, individual investors and others. Once the asset value per share has been determined at step 507, the next step 509 is to determine the asset value of each investor's shares. This is determined by using information on each investor's investments 104, such as the number of shares 204 held by each investor.

As a separate, parallel functionality, the method of the present invention at step 520 also tracks information specific to each investor's investments 520 using the general market inputs 101 and the information on each investors investment 104. Using this information, the next step 522 is to determine the differential fees or credits, if any, owed by or to each investor. Using the value of the fees and credits determined in step 522 in conjunction with the total asset value of each investor's shares determined in step 509, the next step 511 is to determine the net asset value, or realizable value, for each investor. In this way, the true value of the investor's investment to that investor is determined by subtracting out the fees and adding the credits to the total asset value of his shares.

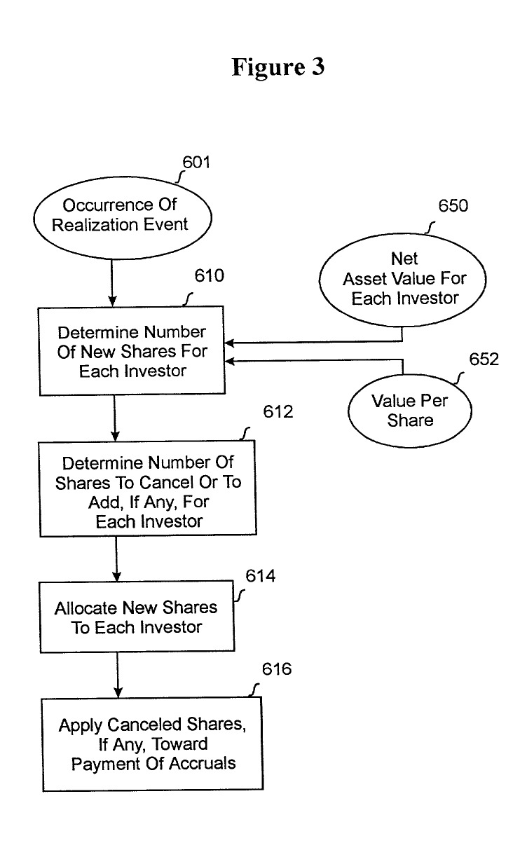

FIG. 3 illustrates the additional steps of the present method which are performed upon the occurrence of a realization event 601. Note, however, that the steps outlined in FIG. 2 also need not be performed until the occurrence of the realization event 601. However, upon occurrence of a realization event, and assuming that the process has proceeded through step 511, namely the determination of the net asset value for each investor 650, that value is used in conjunction with the value per share 652 which was determined in step 507, to determine at step 610 the new number of shares held by each investor. As before, not all of these steps need be performed in a particular order, unless the value from the previous step is required to perform the subsequent step. Next, the number of shares which should be cancelled from or added to each investor, if any, is determined at step 612. For each investor owing a PF, the number of such investor's shares to be cancelled to provide for the payment of such PF is known, and such shares shall, in face, be cancelled to provide for the payment of the PF (accrual) at step 616. For each investor entitled to a credit, step 614 provides for the allocation of new shares to be issued to such investor.

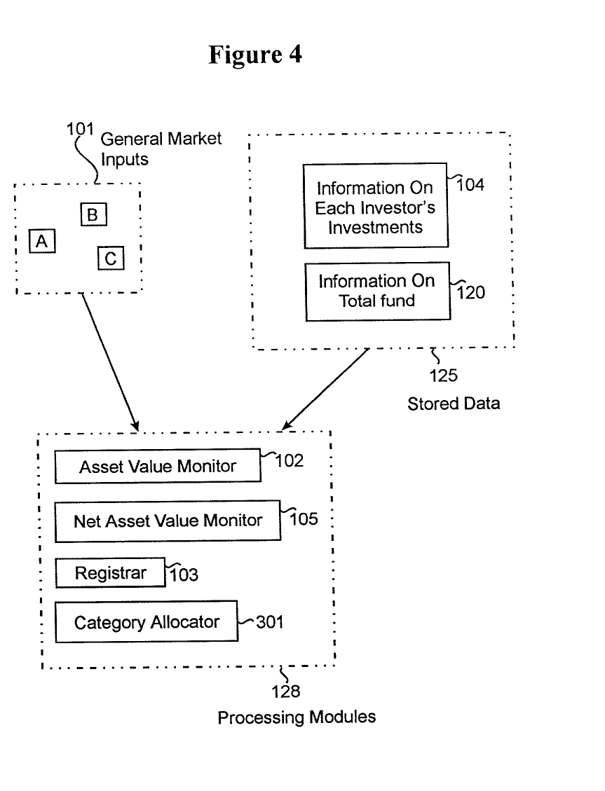

FIG. 4 is a schematic representation of the apparatus of a second embodiment of the present invention. Note that, as with the first embodiment illustrated in FIG. 1, the second embodiment also comprises a stored data 125 and processing modules 128. Note also, that the processing modules 128 of the second embodiment also include a category allocator 301. As before, the various elements contained within the processing modules 128 designate functionalities rather than separate mechanisms. As such, the invention is intended to encompass an apparatus which performs the functions described herein, notwithstanding the mechanisms or labeling of the subsystems of that apparatus.

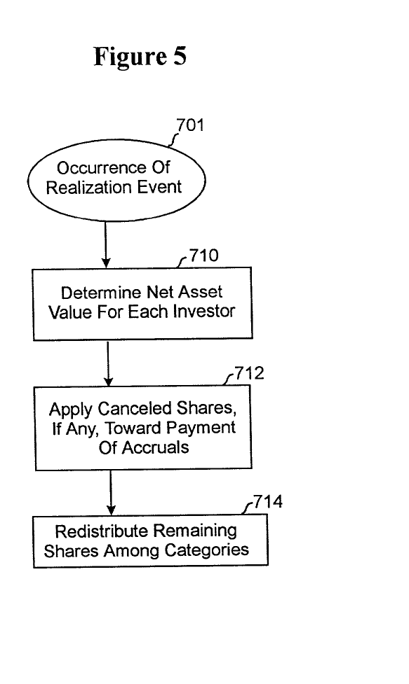

FIG. 5 shows the steps involved in the present invention which are triggered upon the occurrence of a realization event 701. The first step 710 is to determine the net asset value for each individual investor. Note that this can be accomplished in much the same way as the steps leading up to step 511 illustrated in FIG. 2. Following step 710, in step 712 the cancelled shares are applied toward the payment of any PFs (fees/accruals) that may be due. Finally, in step 714, the remaining shares, i.e., those not applied toward the payment of PFs, are redistributed among the various categories of shares held by the investor. This redistribution or reallocation can be performed by any input or predetermined method, and can be included among the information on each investor's investments 104 contained in stored data 125. As before, the methods can also contain the additional step of reporting the new number of shares in each category to each investor (not shown). The categories may be distinguished from each by any number of different characteristics as the fund manager may determine. [i would strike the “or additional” from box 714]

The present invention achieves the objective of maintaining entirely fungible and uniform shares in a fund, while permitting virtually infinite variety in the terms applicable differentially to each investor's investment in such fund, by tracking such different terms outside of the share asset value accounting system and then combining such tracking with a share asset value accounting system which maintains such entirely fungible and uniform shares.

### EXAMPLE 1

TABLE 8

| | T₁ | T₂ | T_{3A} | T_{3B} |
|---|---|---|---|---|
| Uniform Asset | $100 | $110 | $110 | $110 |
| Value per Share | | | | |
| I₁ Shareholding | 1 | 1 | 1 | 108/110 |
| I₂ Shareholding | 0 | 1 | 1 | 1 |

In Example 1 (Table 8) of the present invention, two investors each purchase one share in the same fund at different points in time. By monitoring general market inputs (FIG. 2, step 501), the total value of the fund can be determined (FIG. 2, step 505), and from that the asset value per share can be determined (FIG. 2, step 507). In this example, the asset value per share is determined to be $100 at T₁, $110 at T₂, and $110 at T₃ (note that T_{3A} refers to the time just prior to a realization event, and T_{3B} refers to the time immediately following the realization event). Investor I₁ purchases one share for $100 at T₁, while investor I₂ purchases one share at T₂, at which time the share asset value is $110. Again, these numbers are asset value figures, not net asset value figures. By T₃, the asset value per share has held steady at $110 each.

Under the method of the present invention, a separate accounting is kept (FIG. 2, step 520), and at T₃, the system recognizes that investor I₁ owes $2 in PFs, and that investor I₂ owes nothing (FIG. 2, step 522). Therefore, at the beginning of the next period, represented as T_{3B}, assuming a realization event has occurred between T_{3A} and T_{3B} (FIG. 3, 601), this method cancels shares of investor I₁ in payment of the PFs due at T₃ (FIG. 3, step 612). In this case, at T_{3B}, investor I₁'s total investment, after deduction of $2 of PFs, is $108. With a $110 share value, investor I₁ holds 108/110 of a share (FIG. 3, steps 610 and 614). Similarly, investor I_{2'}s total investment is $110, since he has paid no PFs. At $110 a share, investor I₂ thus holds exactly one share. The 2/110 share cancelled from investor I₁ is then applied toward the payment of the $2 accrued PF (FIG. 3, step 616).

### EXAMPLE 2

TABLE 9

| | T₁ | T₂ | T₃ | T_{4A} | T_{4B} |
|---|---|---|---|---|---|
| Uniform Asset | $100 | $90 | $90 | $95 | $95 |
| Value per | | | | | |
| Share | | | | | |
| I₁ Shareholding | 1 | 1 | 1 | 1 | 1 |
| I₁ loss | 0 | 10 | 10 | 5 | 5 |
| carryforward | | | | | |
| I₂ Shareholding | 0 | 1 | 1 | 1 | 94/95 |
| I₂ loss | 0 | 0 | 0 | 0 | 0 |
| carryforward | | | | | |

The example shown in Table 9 demonstrates another feature of the present invention. Importantly, the cancellation of shares does not occur until a realization event, in this case, a payment of PFs. Accrued fees, as opposed to fees when paid, do not affect the share accounting system, but rather are stored in the individual investor identifier systems. This is appropriate because until an accrued PF is actually due, the amount of the accrual still represents investor assets at risk and should be included in making the fund's accounting allocations. In the example illustrated in Table 9, the asset value per share at T₁ is $100, at T₂ is $90, at T₃ is $90, and at T₄ is $95. Again, T_{4A} and T_{4B} refer to times immediately prior to, and immediately subsequent to, the realization event, respectively. They are separated to show the difference in shareholdings before and after the realization event. Investor I₁ purchases one share at T₁, while investor I₂ purchases one share at T₂. At T_{4A}, investor I₂ has a net gain of $5, and thus owes a $1 PF to the advisor (again, assuming a 20% PF). However, the asset value of both I₁'s and I₂'s share is a uniform $95. The individual investor identifier system, however, recognizes that investor I₁ has a net loss of $5 since the inception of his investment. Under these circumstances, investor I₁ has a $5 loss carryforward. Therefore, if a PF realization event occurs at T₄, investor I₁ retains one share at a $95 asset value. Investor I_{2,} however, has a total investment of $94, and has $1 worth of asset value shares cancelled to pay the $1 PF owed by I₂. At $95 a share, this means that investor I₂ will retain 94/95 of a share.

### EXAMPLE 3

TABLE 10

| | T₁ | T₂ | T₃ | T_{4A} | T_{4B} |
|---|---|---|---|---|---|
| Asset Value | $100 | $90 | $90 | $100 | $100 |
| per Share | | | | | |
| I₁ Shareholding | 1 | 2 | 1 | 1 | 99/100 |
| I₁ loss | 0 | $10 | $5 | $5 | 0 |
| carryforward | | | | | |
| I₁ accruals (at | 0 | 0 | 0 | $1 ($(10-5) × | 0 |
| 20%) | | | | 20%) | |
| I₂ Shareholding | 1 | 1 | 1 | 1 | 1 |
| I₂ loss | 0 | $10 | $10 | 0 | 0 |
| carryforward | | | | | |
| I₂ accruals (at | 0 | 0 | 0 | 0 | 0 |
| 20%) | | | | | |

The example shown in Table 10 demonstrates how the method of the present invention can successfully track multiple investments by multiple investors. In the example illustrated in Table 10, the asset value per share at T₁, is $100, at T₂ is $90, at T₃ is $90, and at T₄ is $100. For purposes of Example 3, assume that investor I₁ purchases one share at T₁, and a second share at T₂. Assume further that investor I₁ redeems his second share at T₃. Investor I_{2,} on the other hand, purchases one share at T₁, and does not redeem it.

Upon redemption of a share at T₃, investor I₁ loses one-half of his loss carryforward according to typical fund accounting practices, since he has redeemed one-half of his investment (one out of two shares). Therefore, beginning at T₃, investor I₁'s loss carryforward is $5, although the asset value of his single remaining share is $10 below the purchase price at T₁, of $100. Thus, at T_{4A}(immediately prior to the realization event), investor I₁ has gained $10, and has only a $5 loss carryforward, thus yielding a net increase subject to the PF of $5. Assuming a 20% PF, investor I₁ owes $1 to the advisor.

According to the present invention, investor I₁'s investment in the fund at T_{4B} (after occurrence of the realization event) is $99 ($100, minus the $1 PF). At an asset value of $100 a share, investor I₁ retains 99/100 share at T_{4B}. As for investor I₂, he still has a $100 stake in the fund at T_{4B}. Therefore, at $100 a share, he owns exactly one share at T_{4B}.

The present invention can be modified to adopt to any manner of PF (or other) calculations, irrespective of how many times, or in what patterns, an investor invests, redeems and reinvests in a fund.

### EXAMPLE 4

TABLE 11

| | T₁ | T₂ | T_{3A} | T_{3B} |
|---|---|---|---|---|
| Asset Value Per | $100 | $110 | $110 | $110 |
| Share | | | | |
| I's share | 1 | 2 | 1 | 1* |
| holdings | | | | |
| I's loss | 0 | 0 | 0 | 0 |
| carryforward | | | | |
| I's accruals (at | 0 | $2 | $1 | $1 |
| 20%) | | | | |
| *In this example, two operations occur at T₃: the investor redeems one share, and there is a realization event - the payment of accrued PFs. As discussed below, if the $1 PF owed at T_{3A} is paid from the proceeds of the share redemption, then the investor retains one share at T_{3B}. If, however, the investor does not pay the $1 PF from the redemption proceeds of the share, then the fee can be obtained through cancellation of 1/110 share, leaving the investor with | | | | |
| #109/110 share at T_{3B}. | | | | |

Table 11 illustrates another example of an investor buying shares at two different times in the same fund in accordance with the present invention. In this case, referring to Table 11, the asset value per share is $100 at time T₁, $110 at T₂, and $110 at T₃ (Note that T_{3A}refers to the time just prior to a realization event, and T_{3B}refers to the time immediately following this realization event). The investor purchases one share at T₁ and retains it. That same investor purchases another share at T₂, and redeems it at T₃.

The PF accrued by this investor at T₃ is $2 (20% of the $10 increase experienced by the first share he purchased). Since the investor has redeemed half of his shares, according to typical fund accounting practices, he owes half of the PF (½×$2=$1), even though there is no gain whatsoever on the share purchased at T₂. In this case, after payment of the $1 PF from the $110 redemption proceeds, the investor's total net assets in the fund are $109, one $110 asset value share, less the remaining $1 accrued PF. Alternatively, the present invention can be adjusted so that the redemption proceeds of $ 110 are paid out and an additional fractional share canceled to pay the PF, with the investor retaining 109/110 share.

Note that despite the number of shares held by an investor being subject to change, under the present invention the change in the uniform asset value per share from T_{X} to T_{X+1} correctly reflects the performance of the fund, gross of PFs, for such period.

An embodiment of the present invention which relates to the attribution of the shares held by a single investor or a plurality of investors to different categories (which could reflect a wide variety of possible variables) addresses the problem of distributing among such categories quantities—such as PF accruals or reversals—which apply not category-by-category but investor-by-investor. There is a fundamental discontinuity between a quantity calculated on the basis of a shareholder's overall investment in a fund (for example, PFs) and categories which potentially are, by definition, only a portion of such overall investment.

For example, assume that a fund offers shares that are redeemable either quarterly or annually and that the same investor may hold both types. Problems generally analogous to those which arise under the EF/DD and/or “equalization share” schemes when the same investor purchases shares at multiple times arise in the case of different categories of shares acquired by the same investor at different times (in this case quarterly and annual redemption shares). Assume an investor is holding annual shares on which PFs have accrued at the time that the same investor acquires quarterly redemption shares. If the fund subsequently has neither profits nor losses, and the quarterly shares are redeemed prior to the end of the current PF calculation period, part of the PF accrued on the annual shares will become payable. This creates the accounting issue of whether payment of that PF should reduce the number of annual shares and/or quarterly shares held by the shareholder or the proceeds of the quarterly redemption. Analogous attribution issues arise if annual shares are redeemable at different anniversary dates since, among other things, one must decide from which category (or subcategory), if any, of annual redemption shares should shares be cancelled to pay the PF.

Any accounting system which attempts to track categories into which an individual shareholder's investments are divided separately while also applying certain quantities, e.g., PFs, on the basis of the shareholder's overall investments will in certain scenarios be required to make allocations contrary to those which would be made to any individual category considered in isolation. The present invention resolves this problem by accounting for the categories not as independent subsets of an investor's shareholding to which specific shares are identified, but rather as pro rata percentages of such shareholding.

### EXAMPLE 5

TABLE 12

| | T₁ | T₂ | T₃ | T_{4A} | T_{4B} |
|---|---|---|---|---|---|
| Uniform | $100 | $110 | $110 | $110 | $110 |
| Asset Value | | | | | |
| per Share | | | | | |
| No. Annual Shares | 2 | 2 | 2 | 2 | 1.976 |
| No. Quarterly Shares | 0 | 1 | 0.5 | 0.5 | 0.494 |

Example 5 (Table 12) illustrates a second embodiment of the present invention. In this hypothetical, the asset value per share is $100 at T₁, $110 at T₂, $110 at T₃, and $110 at T₄. At T₄, a realization event occurs (the payment of PFs). T_{4A}represents the status of the investor's shares just prior to occurrence of the realization event, while T_{4B} represents the status of the investor's shares immediately following the realization event and reallocation of shares according to the present invention.

In this example, an investor purchases two annual redemption shares for $100 each at T₁. By T₂, these shares have an asset value of $110 each. At T₂, the investor purchases one quarterly redemption share (which of course also has an asset value per share of $110). At T₃, the investor redeems ½ of a quarterly share. One-half of the quarterly share has an asset value of $55 ($110×½ =$55). At T₃, the investor's total gain on his investment is $20 ($10 on each of his two annual shares, purchased at T₁). Therefore, the total accrued PF at T₃, assuming again a 20% PF, is $4 ($20×20%=$4). Since the investor has redeemed ⅙ of his total investment (½ share out of 3 shares total), he only owes ⅙ of the accrued PF upon his redemption of ½ of a quarterly share. Thus, the investor owes $0.67 in PFs at T₃ ($4×⅙=$0.67). In this example, this amount is assumed to be paid out of redemption proceeds.

As mentioned previously, a realization event then occurs at T₄, namely the payment of the accrued PF to the fund manager (FIG. 5, 701). As a result, the investor's shares must be redistributed between the two types of shares he holds, annual and quarterly shares (FIG. 5, step 714). At T_{4A}, the investor's total asset value is $275 (2.5 shares×$110share). Since the asset value per share has not changed from T₃ to T₄, the investor's total gains are still $20. However, the investor has already paid $0.67 of the $4 PF owed on this $20 gain. Thus, at T_{4A}, the investor owes $3.33 in PFs ($4−$0.67 =$3.33). Therefore, after the payment of accrued PFs (i.e., at T_{4B}), the investor's total investment will be $271.67 ($275-$3.33) (FIG. 5, step 710). The $3.33 will be paid through the cancellation of shares (FIG. 5, step 712).

According to this embodiment of the present invention, the $271.67 must then be allocated between the investor's two different types of shares. Just prior to the realization event (i.e., at T_{4A}), the investor had 2 annual redemption shares and ½ of a quarterly redemption share. Thus, ⅘ of his investment was in annual redemption shares, and ⅕ of his investment was in quarterly redemption shares. In this example, these percentages should remain constant after occurrence of the realization event. Therefore, at T_{4B}, the investor should be reallocated annual redemption shares worth $217.34 (⅘×$271.67) and quarterly redemption shares worth $54.33 (⅕×$271.67). With an asset value per share of $110, the investor is thus allocated 1.976 annual redemption shares ($217.34÷$110 share) and 0.494 quarterly redemption shares ($54.33 ÷$110/share).

Combining the first and second embodiments of the present invention creates a highly flexible, multi-dimensional accounting system which can accommodate virtually any permutation of both (i) investor versus investor differentials and (ii) differential characteristics defining different subsets of each individual investor's own shares—all in a computerized, fully-automated functionality which maintains wholly fungible and uniform shares at all times, without path dependence with respect to either the pattern of fund performance or of investors' subscriptions.

The examples contained herein are merely illustrative of the invention as a whole, and are not intended in any manner to limit the scope of the claimed invention. As should be clear to any person of ordinary skill in the art, numerous modifications could be made which would still be encompassed by this invention.

What is claimed is:

1. A computer-implemented method of accounting for an investment fund, said investment fund comprising a plurality of shares having a uniform asset value, said investment fund further comprising a plurality of investors, wherein each investor of said plurality of investors owns a number of shares, said method comprising the steps of:
tracking the uniform asset value per share; and
calculating fees such as PFs owed by or credits owed to each investor, if any, among said plurality of investors.

2. The method of accounting according to claim 1, wherein said uniform asset value per share does not reflect said fees or said credits, if any.

3. The method of accounting according to claim 2, wherein said uniform asset value per share is reported to a stock exchange or other third-party data gatherer.

4. The method of accounting according to claim 2, further comprising the step of adjusting the number of shares owned by each investor of said plurality of investors upon the occurrence of a realization event to reflect the payment of fees or receipt of credits, if any.

5. The method of accounting according to claim 2, wherein the obligation or entitlement of said investors to pay said fees or receive such credits is a separate contractual obligation.

6. A method of accounting in an investment fund, said investment fund comprising a plurality of the total shares outstanding having a total value, said investment fund further comprising a plurality of investors, wherein each investor of said plurality of investors owns a fraction of the plurality of the total shares outstanding, and wherein said fractions each have a value, and wherein said total shares outstanding have a uniform asset value per share, said method comprising the steps of:
monitoring the investments in said investment fund;
tracking the total shares outstanding in said investment fund;
calculating the uniform asset value per share in said investment fund;
tracking the fraction of the plurality of total shares outstanding held by each of said investors in said investment fund;
calculating the value of each fraction of the plurality of total shares outstanding held by each of said investors in said investment fund;
calculating the fees owed by or credits owed to each investor in said investment fund;
calculating the net asset value of each of said shares owned by each of said investors in said investment fund.

7. The method according to claim 6, wherein prior to a realization event, said investors have a first number of shares, and wherein subsequent to said realization event, said investors hold a second number of shares, wherein said second number of shares can be different from said first number of shares by a number of shares cancelled for fees or added for credits, said method further comprising the steps of:
calculating the second number of shares to be issued to each investor upon occurrence of the realization event;
calculating the number of shares cancelled or added, if any;
reissuing the second number of shares to each of said investors; and
delivering the cancelled shares or the proceeds thereof against fees, if any.

8. A method of accounting for an investment fund, said investment fund having a plurality of shares and a plurality of categories of shares, said investment fund further comprising a plurality of investors, each investor among said plurality of investors having shares in at least one category of said plurality of categories of shares, said method comprising the steps of:
tracking the shares held by each of said investors,
tracking the categories of shares held by each of said investors;
redistributing shares among the categories held by each of said investors upon occurrence of a realization event; and
canceling shares to account for accruals or adding shares to account for credits, if any, upon occurrence of a realization event.

9. The method according to claim 8, further comprising the step of notifying each of said investors as to the number of shares distributed to each category held by said investor after occurrence of said realization event.

10. An apparatus for use in regulating an investment fund having investors, said investors each having an investment in said investment fund, said apparatus comprising:
a memory storage device capable of storing information relating to the investment fund as a whole, and said memory storage device further capable of storing information relating to the investments of each of said investors in said investment fund; and
a processor, capable of receiving general market inputs and input from said memory storage device, wherein said processor is further capable of determining a uniform share value which does not reflect fees or credits, if any, wherein said processor is further capable of individually tracking the fees owed by each of said investors, and wherein said processor is capable of determining a net asset value for each of said investors.

11. An apparatus according to claim 10, wherein said processor is further capable of reallocating fewer or more shares to each of said investors upon the occurrence of a realization event, if said investor owes fees or receives credits.

12. An apparatus according to claim 11, wherein said processor is further capable of canceling or issuing a number of shares sufficient for the payment of fees owed by or credits owed to any investor among said investors which owes fees or is owed credits.

13. An apparatus according to claim 11, wherein said memory storage devise is further capable of storing information relating to different categories of shares, and wherein said processor is further capable of distributing shares remaining after said realization event into said different categories according to a predetermined method.

14. A method implemented in a computer system for the management of an investment fund to maintain a uniform share price for all investors in the investment fund and for paying a PF to a fund manager based on investor gains in the investment fund, comprising the steps of:
determining on a repeating basis the value of shares in said fund, wherein said share value is uniform among all shares and is dependent upon investments made by said fund, and wherein said share value does not reflect any fees or credits incidental to the management of the fund, and upon occurrence of a realization event for the fund, performing the steps of:
(a) determining those of said investors in said fund which have incurred gains in value for their investments during a period of time,
(b) determining the amount of the gain for each said investor which has recognized a gain,
(c) determining a PF owed to said fund manager for each said investor which recognized a gain on such investor's shares based on the amount of said gain,
(d) reducing the number of shares held by each said investor which recognized a gain by a selected amount wherein the value of the reduced number of shares is equal to the PF owed by the investor to said fund manager,
(e) determining those of said investors in said fund which have incurred losses in value for their investments in the fund during a period of time,
(f) determining the amount of the loss for each said investor which has incurred a loss,
(g) maintaining a running loss carryforward for each said investor which incurred a loss, and
(h) using the loss carryforward in calculating subsequent PFs and redistributions of shares.
